(19) United States
(12) Patent Application Publication
(10) Pub. No.: US 2018/0312320 A1
(43) Pub. Date: Nov. 1, 2018

(54) Heated Case Assembly

(71) Applicant: Francis X. Awity, Monterey, CA (US)

(72) Inventor: Francis X. Awity, Monterey, CA (US)

(21) Appl. No.: 15/581,099

(22) Filed: Apr. 28, 2017

(51) Int. Cl. B65D 81/18; F24C 7/10; F25D 11/00; F25D 23/06; F25D 31/00; B65D 43/16; B65D 25/04; B65D 81/38; B65D 55/02; B65D 43/22; B65D 25/28; H02S 40/38; H02J 7/35; H02J 7/00

(52) U.S. Cl. CPC B65D 81/18; B65D 2525/283; F25D 11/003; F25D 23/069; F25D 31/005; B65D 43/163; B65D 25/04; B65D 81/38; B65D 55/02; B65D 43/22; B65D 25/28; H02S 40/38; H02J 7/35; H02J 7/0013; F25D 2400/02; F24C 7/10

(57) ABSTRACT

A heated case assembly for carrying temperature sensitive items includes a case that may contain a heated item, a cooled item and a non-temperature sensitive item. A lid is hingedly coupled to the case and the lid selectively closes the case. A heater is coupled to the case and the heater selectively heats the heated item. A cooler is coupled to the case and the cooler selectively cools the cooled item.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to case devices and more particularly pertains to a new case device for carrying temperature sensitive items.

### BRIEF SUMMARY OF THE INVENTION

An embodiment of the disclosure meets the needs presented above by generally comprising a case that may contain a heated item, a cooled item and a non-temperature sensitive item. A lid is hingedly coupled to the case and the lid selectively closes the case. A heater is coupled to the case and the heater selectively heats the heated item. A cooler is coupled to the case and the cooler selectively cools the cooled item.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a heated case assembly according to an embodiment of the disclosure.

FIG. 2 is a bottom phantom view of an embodiment of the disclosure.

FIG. 3 is a top perspective view of an embodiment of the disclosure.

FIG. 4 is a front phantom view of an embodiment of the disclosure.

FIG. 5 is a cross sectional view taken along line 5-5 of FIG. 4 of an embodiment of the disclosure.

### DETAILED DESCRIPTION OF THE INVENTION

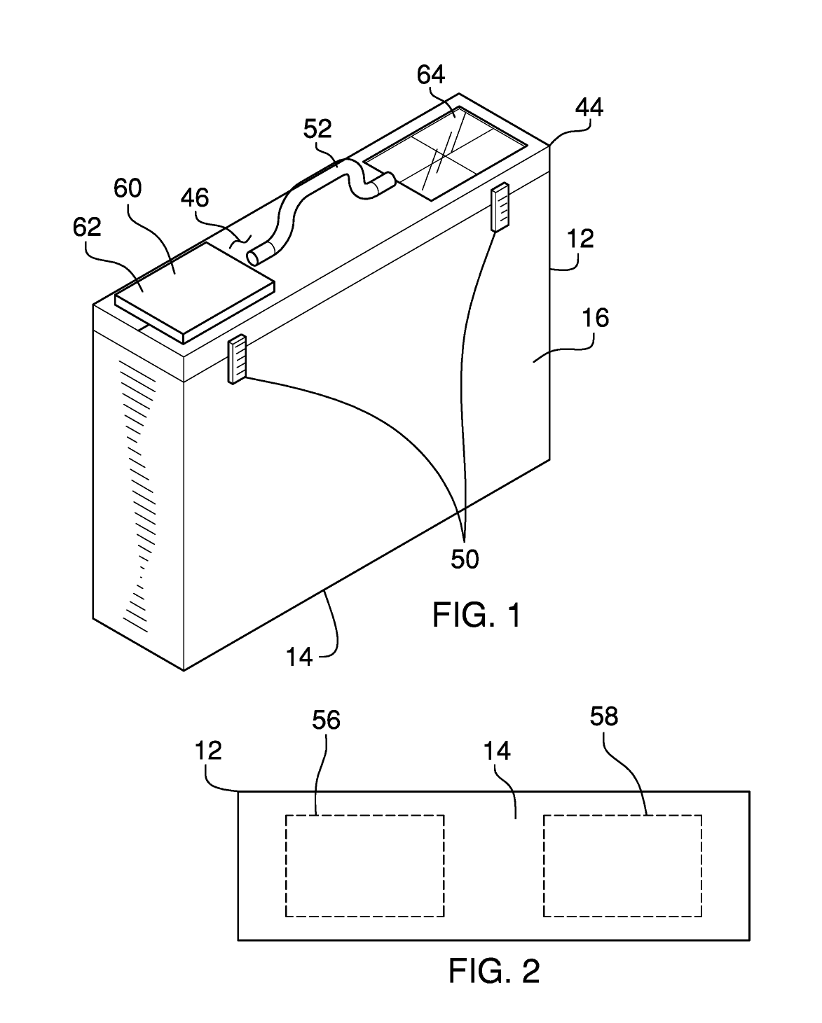

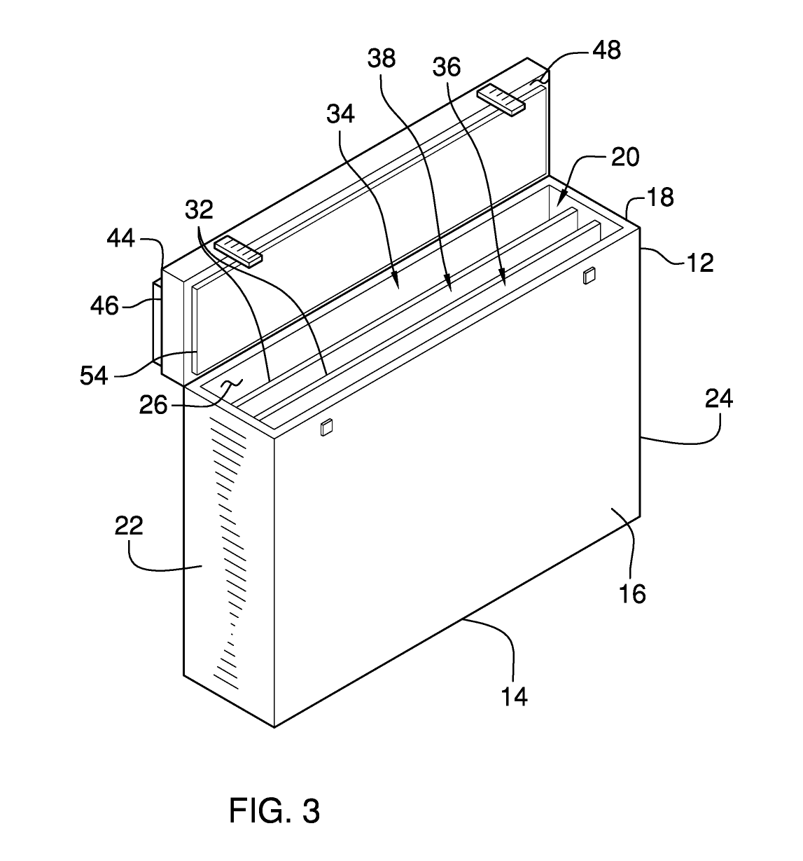

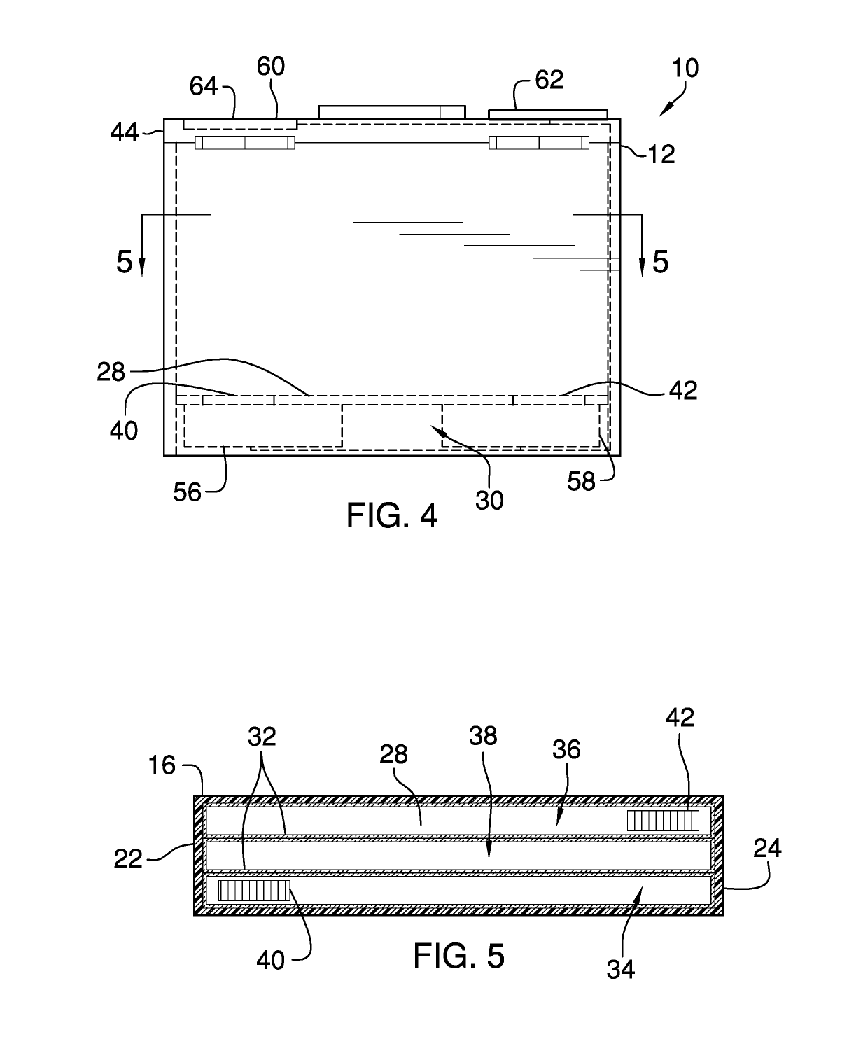

With reference now to the drawings, and in particular to FIGS. 1 through 5 thereof, a new case device embodying the principles and concepts of an embodiment of the disclosure and generally designated by the reference numeral 10 will be described.

As best illustrated in FIGS. 1 through 5, the heated case assembly 10 generally comprises a case 12 that has a bottom wall 14 and an outer wall 16 extending away therefrom. The outer wall 16 has a distal edge 18 with respect to the bottom wall 14 and the distal edge 18 defines an opening 20 into an interior of the case 12. The case 12 is comprised of a thermally insulating material and the outer wall 16 has a first lateral side 22, a second lateral side 24 and an inside surface 26.

A first divider 28 is positioned within the case 12 and the first divider 28 is spaced from the bottom wall 14 to define an equipment space 30 within the case 12. The first divider 28 is comprised of a thermally insulating material. A plurality of second dividers 32 is provided and each of the second dividers 32 is positioned within the case 12. Moreover, the second dividers 32 are spaced apart from each other to define a hot space 34, a cold space 36 and a regular space 38 within the case 12. The hot space 34 may contain a heated item and the heated item may be any temperature sensitive item needing to be kept above a minimum temperature. The cold space 36 may contain a cooled item and the cooled item may be any temperature sensitive item needing to be kept below a maximum temperature. The regular space 38 may contain a non-temperature sensitive item.

Each of the second dividers 32 extends between the first divider 28 and the distal edge 18 of the case 12. Moreover, each of the second dividers 32 extends between the inside surface 26 corresponding to each of the first lateral side 22 and the second lateral side 24. Each of the second dividers 32 is comprised of a thermally insulating material. In this way the plurality of second dividers 32 inhibit thermal communication between the heated item, the cooled item and the non-temperature sensitive item.

A first vent 40 extends through the first divider 28 and the first vent 40 is aligned with the hot space 34. Thus, the hot space 34 is in thermal communication with the equipment space 30. A second vent 42 extends through the second divider and the second vent 42 is aligned with the cold space 36. In this way the cold space 36 is in thermal communication with the equipment space 30.

A lid 44 is hingedly coupled to the case 12 such that the lid 44 selectively closes the case 12. The lid 44 has a top surface 46 and a bottom surface 48 and the lid 44 is positioned on the distal edge 18 of the case 12. A pair of locks 50 is provided and each of the locks 50 is movably coupled to the lid 44. Each of the locks 50 engages the case 12 when the lid 44 is closed to retain the lid 44 in a closed position. A handle 52 is coupled to the top surface 46 of the lid 44 and the handle 52 is gripped.

A prominence 54 is coupled to the bottom surface 48 of the lid 44 and the prominence 54 is spaced from a perimeter edge of the lid 44. The prominence 54 fills the opening 20 when the lid 44 is closed. In this way the prominence 54 inhibits air from passing into the case 12 when the lid 44 is closed. Each of the lid 44 and the prominence 54 is comprised of a thermally insulating material.

A heater 56 is provided and the heater 56 is coupled to the case 12. The heater 56 is positioned within the equipment space 30 and the heater 56 is aligned with the first vent 40. In this way the heater 56 is in thermal communication with the hot space 34. The heater 56 heats the hot space 34 when the heater 56 is turned on to heat the heated item. The heater 56 may be an electric heater 56 of any conventional design.

A cooler 58 is provided and the cooler 58 is coupled to the case 12. The cooler 58 is positioned within the equipment space 30 and the cooler 58 is aligned with the second vent 42. In this way the cooler 58 is in thermal communication with the cold space 36. The cooler 58 cools the cold space 36 when the cooler 58 is turned on to cool the cooled item. A control may be provided and the control may be coupled to the case 12. The control may be electrically coupled to each of the heater 56 and the cooler 58 to control operational parameters of the heater 56 and the cooler 58. The control may be an electronic control that may include, but not be limited to, temperature control and power control.

A power supply 60 is provided and the power supply 60 is coupled to the lid 44. The power supply 60 is electrically coupled to each of the heater 56 and the cooler 58. The power supply 60 comprises at least one battery 62 that is positioned on the top surface 46 of the lid 44. A solar panel 64 is positioned on the top surface 46 of the lid 44. In this way the solar panel 64 is selectively exposed to sunlight. The solar panel 64 is electrically coupled to the at least one battery 62 such that the solar panel 64 charges the at least one battery 62.

In use, the heated item is selectively positioned in the hot space 34, the cooled item is selectively positioned in the cold space 36 and the non-temperature sensitive item is selectively positioned in the regular space 38. The lid 44 is closed and the control is manipulated to control the operational parameters of the heater 56 and the cooler 58. In this way the heated item it retained above a minimum temperature and the cooled item is retained below a maximum temperature. Each of the heated item, said cooled item and the non-temperature sensitive item may be carried together or independently in the case 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A heated case assembly being configured to transport temperature sensitive items, said assembly comprising:
a case being configured to contain a heated item, a cooled item and a non-temperature sensitive item;
a lid being hingedly coupled to said case such that said lid selectively closes said case;
a heater being coupled to said case wherein said heater is configured to heat the heated item; and
a cooler being coupled to said case wherein said cooler is configured to cool the cooled item.

2. The assembly according to claim 1, further comprising:
said case having a bottom wall and an outer wall extending away therefrom, said outer wall having a distal edge with respect to said bottom wall, said distal edge defining an opening into an interior of said case, said case being comprised of a thermally insulating material, said outer wall having a first lateral side, a second lateral side and an inside surface; and
a first divider being positioned within said case, said first divider being spaced from said bottom wall to define an equipment space within said case, said first divider being comprised of a thermally insulating material.

3. The assembly according to claim 1, further comprising a plurality of second dividers, each of said second dividers being positioned within said case, said second dividers being spaced apart from each other to define a hot space, a cold space and a regular space within said case, said hot space being configured to contain a heated item, said cold space being configured to contain a cooled item, said regular space being configured to contain a non-temperature sensitive item.

4. The assembly according to claim 3, wherein:
said case includes a distal edge and a first divider; and
each of said second dividers extends between said first divider and said distal edge of said case, each of said second dividers extending between said inside surface corresponding to each of said first lateral side and said second lateral side, each of said second dividers being comprised of a thermally insulating material wherein said plurality of second dividers is configured to inhibit thermal communication between the heated item, the cooled item and the non-temperature sensitive item.

5. The assembly according to claim 4, further comprising:
an equipment space being defined by said first divider; and
a first vent extending through said first divider, said first vent being aligned with said hot space such that said hot space is in thermal communication with said equipment space.

6. The assembly according to claim 4, further comprising:
an equipment space being defined by said first divider; and
a second vent extending through said second divider, said second vent being aligned with said cold space such that said cold space is in thermal communication with said equipment space.

7. The assembly according to claim 1, further comprising a pair of locks, each of said locks being movably coupled to said lid wherein each of said locks is configured to be manipulated, each of said locks engaging said case when said lid is closed to retain said lid in a closed position.

8. The assembly according to claim 2, further comprising a prominence being coupled to a bottom surface of said lid, said prominence being spaced from a perimeter edge of said lid, said prominence filling said opening when said lid is closed wherein said prominence is configured to inhibit air from passing into said case when said lid is closed, each of said lid and said prominence being comprised of a thermally insulating material.

9. The assembly according to claim 5, wherein said heater is positioned within said equipment space, said heater being aligned with said first vent such said heater is in thermal communication with said hot space, said heater heating said hot space when said heater is turned on.

10. The assembly according to claim 5, wherein said cooler is positioned within said equipment space, said cooler being aligned with said second vent such that said cooler is in thermal communication with said cold space, said cooler cooling said cold space when said cooler is turned on.

11. The assembly according to claim 1, further comprising a power supply being coupled to said lid, said power supply being electrically coupled to each of said heater and said cooler.

12. The assembly according to claim 1, wherein said power supply comprises:
at least one battery being positioned on a top surface of said lid, and
a solar panel being positioned on said top surface of said lid wherein said solar panel is configured to be exposed to sunlight, said solar panel being electrically coupled to said at least one battery such that said solar panel charges said at least one battery.

13. A heated case assembly being configured to transport temperature sensitive items, said assembly comprising:
a case having a bottom wall and an outer wall extending away therefrom, said outer wall having a distal edge with respect to said bottom wall, said distal edge defining an opening into an interior of said case, said case being comprised of a thermally insulating material, said outer wall having a first lateral side, a second lateral side and an inside surface;
a first divider being positioned within said case, said first divider being spaced from said bottom wall to define an equipment space within said case, said first divider being comprised of a thermally insulating material;
a plurality of second dividers, each of said second dividers being positioned within said case, said second dividers being spaced apart from each other to define a hot space, a cold space and a regular space within said case, said hot space being configured to contain a heated item, said cold space being configured to contain a cooled item, said regular space being configured to contain a non-temperature sensitive item, each of said second dividers extending between said first divider and said distal edge of said case, each of said second dividers extending between said inside surface corresponding to each of said first lateral side and said second lateral side, each of said second dividers being comprised of a thermally insulating material wherein said plurality of second dividers is configured to inhibit thermal communication between the heated item, the cooled item and the non-temperature sensitive item;
a first vent extending through said first divider, said first vent being aligned with said hot space such that said hot space is in thermal communication with said equipment space;
a second vent extending through said second divider, said second vent being aligned with said cold space such that said cold space is in thermal communication with said equipment space;
a lid being hingedly coupled to said case such that said lid selectively closes said case, said lid having a top surface and a bottom surface, said lid being positioned on said distal edge of said case;
a pair of locks, each of said locks being movably coupled to said lid wherein each of said locks is configured to be manipulated, each of said locks engaging said case when said lid is closed to retain said lid in a closed position;
a handle being coupled to said top surface of said lid wherein said handle is configured to be gripped;
a prominence being coupled to said bottom surface, said prominence being spaced from a perimeter edge of said lid, said prominence filling said opening when said lid is closed wherein said prominence is configured to inhibit air from passing into said case when said lid is closed, each of said lid and said prominence being comprised of a thermally insulating material;
a heater being coupled to said case, said heater being positioned within said equipment space, said heater being aligned with said first vent such said heater is in thermal communication with said hot space, said heater heating said hot space when said heater is turned on wherein said heater is configured to heat the heated item;
a cooler being coupled to said case, said cooler being positioned within said equipment space, said cooler being aligned with said second vent such that said cooler is in thermal communication with said cold space, said cooler cooling said cold space when said cooler is turned on wherein said cooler is configured to cool the cooled item; and
a power supply being coupled to said lid, said power supply being electrically coupled to each of said heater and said cooler, said power supply comprising:
at least one battery being positioned on said top surface of said lid, and
a solar panel being positioned on said top surface of said lid wherein said solar panel is configured to be exposed to sunlight, said solar panel being electrically coupled to said at least one battery such that said solar panel charges said at least one battery.
